(19) United States
(12) Patent Application Publication
(10) Pub. No.: US 2014/0136376 A1
(43) Pub. Date: May 15, 2014

(54) SYSTEMS AND METHODS FOR CONDUCTING TRANSACTIONS IN AN ONLINE MARKETPLACE

(71) Applicant: CHLOE AND ISABEL, INC., New York, NY (US)

(72) Inventors: George ABBOTT, New York, NY (US); Ward Penney, Brooklyn, NY (US)

(73) Assignee: Chloe and Isabel, Inc., New York, NY (US)

(21) Appl. No.: 13/675,728

(22) Filed: Nov. 13, 2012

(51) Int. Cl. G06Q 20/40

(52) U.S. Cl. CPC G06Q 20/4014; G06Q 30/0643
USPC 705/27.2; 705/44

(57) ABSTRACT

A method includes sending from a user device customer identifier data uniquely associated with a customer and sending from the user device merchandiser identifier data uniquely associated with a merchandiser from a plurality of merchandisers. The method further includes displaying at least one item for sale based on data received from a server. The data is displayed based on a profile associated with the customer identifier and the merchandiser identifier. The method also includes transmitting from the user device data associated with at least one transaction request for the at least one item for sale. The customer identifier data and the merchandiser identifier are accessible via a persistent portion of a user interface of the user device.

### BACKGROUND

Some embodiments described herein relate generally to creating content for an online marketplace and initiating and completing transactions within the marketplace using a persistent interface.

As online marketplaces become a mainstay for merchandisers, it is critical to provide a user-friendly platform to facilitate transactions. In addition to conventional retailers acting as forward-facing merchandisers, individuals can also reach large audiences through an online marketplace. In some scenarios, merchandisers can create and customize their own their own online and in-person business using the platform of a larger retailer. Such platforms, however, are often cumbersome for front-end merchandisers to create and to utilize for initiating and completing transactions for third parties (i.e., customers). What is needed is an online marketplace for front-end merchandisers to effectively initiate and complete transactions in a one-to-one setting as well as, for example, a trunk show setting.

### SUMMARY

In some embodiments, a method includes sending from a user device customer identifier data uniquely associated with a customer and sending from the user device merchandiser identifier data uniquely associated with a merchandiser from a plurality of merchandisers. The method further includes displaying at least one item for sale based on data received from a server. The data is displayed based on a profile associated with the customer identifier and the merchandiser identifier. The method also includes transmitting from the user device data associated with at least one transaction request for the at least one item for sale. The customer identifier data and the merchandiser identifier are accessible via a persistent portion of a user interface of the user device.

In some embodiments, a method includes receiving, from a first user device, a customer identifier. The customer identifier represents one customer identifier from a plurality of customer identifiers. Each customer identifier from the plurality of customer identifiers is uniquely associated with a separate customer. The customer identifier is selectable from a persistent header of the user device. The method includes receiving, from the first user device, a merchandiser identifier. The merchandiser identifier is one merchandiser identifier from a plurality of merchandiser identifiers. Each merchandiser identifier from the plurality of merchandisers is uniquely associated with a merchandiser. The merchandiser is selectable from the persistent header of the first user device. The method also includes receiving a transaction identifier associated with a transaction based on the customer identifier and the merchandiser identifier. In some embodiments, data associated with a transaction completion request is sent. Data associated with a transaction completion in response to the transaction completion request is received.

In some embodiments, a non-transitory processor-readable medium stores code representing instructions to be executed by a processor, the code comprising code to cause the processor to send from a user device customer identifier data uniquely associated with a customer and send from the user device merchandiser identifier data uniquely associated with a merchandiser from a plurality of merchandisers. The code includes instructions to display at least one item for sale based on data received from a server. The data is displayed based on a profile associated with the customer identifier and the merchandiser identifier. The code includes instructions to transmit from the user device, data associated with at least one transaction request for the at least one item for sale. The customer identifier data and merchandiser identifier is accessible via a persistent portion of a user interface of the user device.

### BRIEF DESCRIPTION OF THE FIGURES

FIG. 1 is a schematic block diagram that illustrates a system for conducting transactions in an online marketplace, according to an embodiment.

FIG. 2 is a schematic diagram that illustrates a transaction engine having multiple components and storing multiple software modules, according to another embodiment.

FIG. 3 is a schematic block diagram that illustrates a system for conducting transactions, according to another embodiment.

FIG. 4 is a flow diagram that illustrates a method of conducting a transaction, according to an embodiment.

FIG. 5 is an example of a graphical user interface for use with a system for conducting transactions in an online marketplace, according to an embodiment.

FIG. 6 is an example of a portion of a graphical user interface, according to an embodiment.

FIG. 7 is an example of a portion of a graphical user interface, according to an embodiment.

FIG. 8 is an example of a portion of a graphical user interface, according to an embodiment.

### DETAILED DESCRIPTION

In some embodiments, a method includes sending from a user device customer identifier data uniquely associated with a customer and sending from the user device merchandiser identifier data uniquely associated with a merchandiser from a plurality of merchandisers. The method further includes displaying at least one item for sale based on data received from a server. The data is displayed based on a profile associated with the customer identifier and the merchandiser identifier. The method also includes transmitting from the user device data associated with at least one transaction request for the at least one item for sale. The customer identifier data and the merchandiser identifier are accessible via a persistent portion of a user interface of the user device.

In some embodiments, a method includes receiving, from a first user device, a customer identifier. The customer identifier represents one customer identifier from a plurality of customer identifiers. Each customer identifier from the plurality of customer identifiers is uniquely associated with a separate customer. The customer identifier is selectable from a persistent header of the user device. The method includes receiving, from the first user device, a merchandiser identifier. The merchandiser identifier is one merchandiser identifier from a plurality of merchandiser identifiers. Each merchandiser identifier from the plurality of merchandisers is uniquely associated with a merchandiser. The merchandiser is selectable from the persistent header of the first user device. The method also includes receiving a transaction identifier associated with a transaction based on the customer identifier and the merchandiser identifier. In some embodiments, data associated with a transaction completion request is sent. Data associated with a transaction completion in response to the transaction completion request is received.

In some embodiments, a non-transitory processor-readable medium stores code representing instructions to be executed by a processor, the code comprising code to cause the processor to send from a user device customer identifier data uniquely associated with a customer and send from the user device merchandiser identifier data uniquely associated with a merchandiser from a plurality of merchandisers. The code includes instructions to display at least one item for sale based on data received from a server. The data is displayed based on a profile associated with the customer identifier and the merchandiser identifier. The code includes instructions to transmit from the user device, data associated with at least one transaction request for the at least one item for sale. The customer identifier data and merchandiser identifier is accessible via a persistent portion of a user interface of the user device.

In some embodiments, a non-transitory processor-readable medium stores code representing instructions to be executed by a processor, the code comprising code to cause the processor to receive, from a first user device, a customer identifier. The customer identifier being one customer identifier from a plurality of customer identifiers. Each customer identifier from the plurality of customer identifiers is uniquely associated with a separate customer. The customer identifier is selectable from a persistent header of the user device. The code includes instructions to receive, from the first user device, a merchandiser identifier. The merchandiser identifier is one merchandiser identifier from a plurality of merchandiser identifiers. Each merchandiser identifier from the plurality of merchandisers is uniquely associated with a merchandiser. The merchandiser is selectable from the persistent header of the user device. The code includes instructions to receive a transaction identifier associated with a transaction based on the customer identifier and the merchandiser identifier and to send data associated with a transaction completion request. The code includes instructions to receive data associated with a transaction completion in response to the transaction completion request.

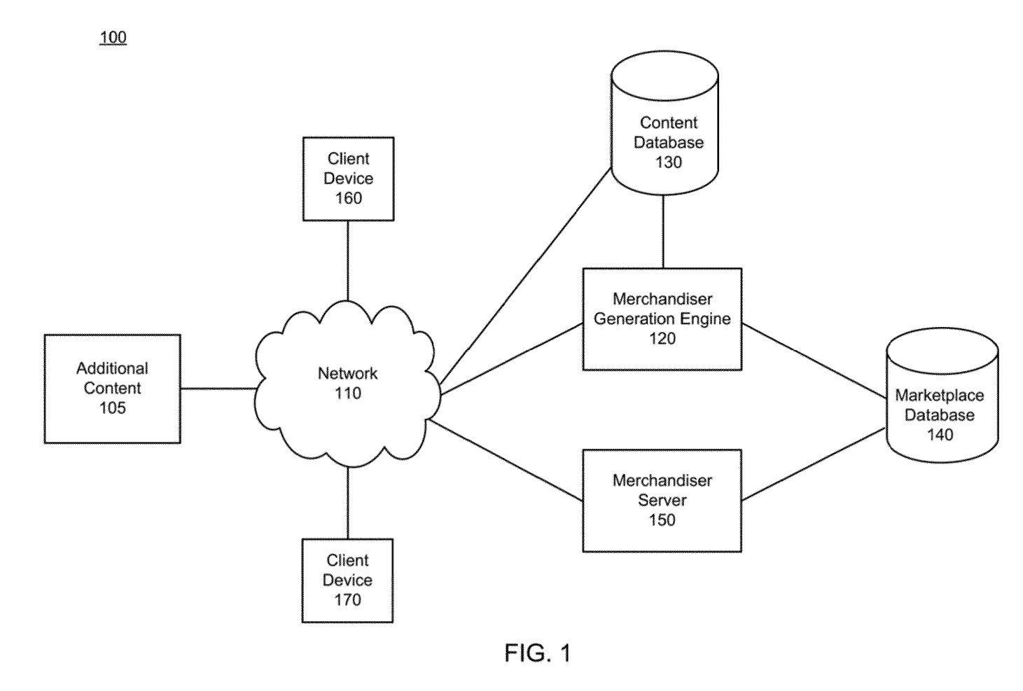

FIG. 1 is a schematic block diagram that illustrates a system for conducting transactions in an online marketplace, according to an embodiment. More specifically, FIG. 1 illustrates a transaction system 100 that includes an additional content provider or providers 105 operatively coupled to a merchandiser generation engine 120 and to a content database 130 via a network 110. The merchandiser generation engine 120 is further coupled to the content database 130 and to a marketplace database 140. The marketplace database 140 is coupled to a merchandiser server 150, which is operatively coupled to a client device 160 and to a client device 170 via the network 110. Although described in a particular fashion, any of the elements described with respect to the configuration of the system can be modified. For example, all of the databases and servers can be resident on a single device or physically distinct devices.

The content database 130 can be a database and/or a database server storing one or more databases including one or more content stores, images, identifiers of one or more persons, designers, places, things, items, events, accessory brands, item descriptors, narratives and/or other information associated with the same. Additionally, the content database 130 can store descriptors, categories of items, characteristics of items (e.g., sizes, colors, quality descriptors, etc.), and/or other information associated with one or more items for sale or other information. In some embodiments, the content database 130 can include one or more relational databases including one or more relational database tables. For example, the content database 130 can include one or more Oracle, Microsoft SQL Server, MySQL, PostgreSQL, Informix and/or other databases storing the information described above.

The additional content provider 105 can be any service or data store that provides content used in facilitating online transactions such as images of items for sale, narrative descriptions of the items for sale, and similar related information. Although not shown in FIG. 1, in some embodiments the additional content provider 105 can itself content from one or more other sources (not shown in FIG. 1). In such embodiments, the additional content provider 105 can aggregate received information for subsequent transmission to, or retrieval from, the merchandiser generation engine 120 and/or the content database 130 via the network 110. In such embodiments, the additional content provider 105 can aggregate the information in a single physical location. Alternatively, the additional content provider 105 can include data from multiple locations, each location being associated with or independent of the additional content provider 105. In some embodiments, the additional content provider 105 can be owned, operated and/or administered by a third-party entity not related and/or affiliated with the other elements of the system 100.

The network 110 can be any computer or information network capable of marshalling, transmitting, routing, directing and/or forwarding data between two or more hardware devices and/or software modules. For example, the network 110 can be a local area network (LAN), a wide area network (WAN) or the Internet. In some embodiments, the network 110 can be comprised of one or more wired and/or wirelessly connected hardware devices. As shown in FIG. 1, the network 110 can operatively couple and/or connect the content provider 105 to the merchandiser generation engine 120 and/or the content database 130. As also shown in FIG. 1, the network 110 can operatively couple and/or connect either or both of the client device 160 and the client device 170 to the merchandiser server 150.

The merchandiser generation engine 120 can be any combination of hardware and/or software (executing in hardware) configured to define content based at least in part on information received from the content provider 105 and/or the content database 130. The merchandiser generation engine 120 can be, for example, a server device executing one or more software modules configured to organize information (e.g., item descriptors, categories and other data received from the content provider 105 and/or the content database 130) within a particular merchandiser's storefront (e.g., a presentation of items selected from the content database 130 or content provider 105) to define and present an online marketplace (e.g., storefront for designer item sales). In addition, the merchandiser generation engine 120 can also receive, from the content database 130, one or more narratives, prices, and/or descriptors associated with the selected content (e.g., items).

In some embodiments, the merchandiser generation engine 120 can be and/or can include multiple hardware modules and/or devices included in a single chassis and/or located within or as separate physical devices. Alternatively, the content generation engine 120 can include multiple physical devices operatively and/or physically coupled via a network (e.g., a private network (not shown in FIG. 1)).

The marketplace database 140 can be a database and/or a database server storing one or more databases including one or more previously-generated merchandiser storefronts defined by the merchandiser generation engine 120. In some embodiments, the marketplace database 140 can include one or more relational databases including one or more relational database tables, similar in structure, type, format, hierarchy and/or organization to those/that included in the merchandiser generation database 130. Although not shown in FIG. 1, the marketplace database 140 can be included in and/or stored at the same physical device as the content database 130. In such embodiments, one or more tables of the marketplace database 140 can optionally be included in the same database as the content database 130. Alternatively, one or more portions of the marketplace database 140 (e.g., entire databases and/or relational database tables) can be stored across multiple devices, such as database server devices (not shown in FIG. 1).

In some embodiments, the marketplace database 140 stores information associated with various merchandisers and customers. In this context, a customer is a customer of the merchandiser, but information associated with the customer is maintained by the system 100. The marketplace database 140 stores information associated with each customer from a plurality of customers as a customer profile or customer account. Such information includes customer name, customer shipping address, customer telephone number, customer payment information, customer username and password, customer e-mail address, etc.

The marketplace database 140 further includes information associated with merchandisers from a plurality of merchandisers. Such information associated with the merchandisers includes merchandiser account number, merchandiser name, merchandiser contact information, merchandiser transaction information, merchandiser sales figures, storefront information, etc.

The merchandiser server 150 can be any combination of hardware and/or software (executing in hardware) configured to serve (i.e., send) storefront content (e.g., previously-generated storefront content stored in the marketplace database 140) to one or more client devices. As shown in FIG. 1, the merchandiser server 150 is operatively coupled, via the network 110, to the client device 160 and to the client device 170. Thus, the merchandiser server 150 can be configured to send content to either or both of the client device 160 and the client device 170. Although not shown in FIG. 1, in some embodiments, the merchandiser server 150 can serve storefront content to any number of client devices connected via the network 110. In this manner, the merchandiser server 150 can send storefront content for consumption by one or more users of one or more client devices. Although not shown in FIG. 1, the merchandiser server 150 can optionally be a physical device operatively coupled to the marketplace database 140. Alternatively, the merchandiser server 150 can be a software module executing at a computing device, such as a server device at which any of the merchandiser generation engine 120, the content database 130 and/or the marketplace database 140 is hosted.

Each of the client device 160 and the client device 170 can be any computing device (e.g., a personal computer, laptop, notebook, netbook, tablet, Smartphone, mobile computing device) configured to receive and/or display storefront content (i.e., graphical and narrative content) received from the merchandiser server 150 via the network 110. For example, the client device 160 can be a personal desktop computer executing a web browser or other client application capable of receiving (e.g., from a web server) and displaying content similar to that described above. In some embodiments, the client device 170 can be, for example, a mobile telephone (e.g., a web-enabled Smartphone) or a tablet device capable of communicating, via the Internet, with one or more web servers and/or databases. In such embodiments, the client device 170 can receive one or more merchandiser storefronts and/or display the same for viewing by a user. Although only two client devices are shown in FIG. 1, in some embodiments any number of compatible client devices can be operatively and/or physically coupled to the network 110, and thus capable of receiving and/or displaying content received from the merchandiser server 150.

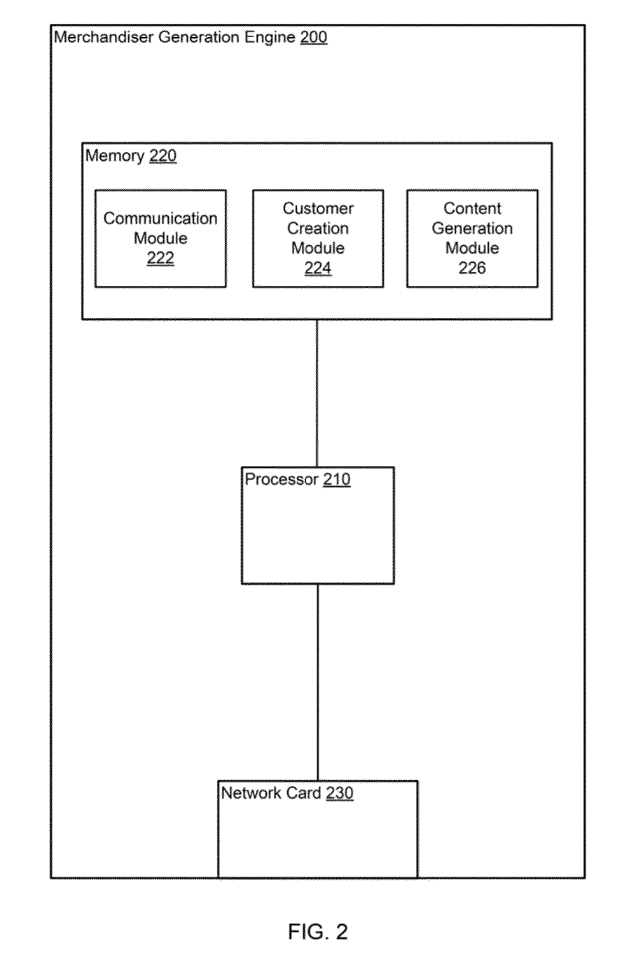

FIG. 2 is a schematic diagram that illustrates a merchandiser generation engine having multiple hardware components and storing multiple software modules, according to another embodiment. More specifically, FIG. 2 is a system block diagram of a merchandiser generation engine 200, similar to the merchandiser generation engine 150 described in connection with FIG. 1 above. The merchandiser generation engine 200 includes a processor 210 operatively coupled to a memory 220 and to a network card 230. As shown in FIG. 2, the memory 220 includes at least three software modules: a communication module 222, a customer creation module 224 and a content generation module 226. In some embodiments, the merchandiser generation engine 200 can include additional hardware modules and/or software modules (executing in hardware) not shown in FIG. 2. For example, the merchandiser generation engine 200 can include one or more input devices and/or peripherals, one or more data input ports, etc.

The processor 210 can be any processor (e.g., a central processing unit (CPU), an application-specific integrated circuit (ASIC), a field programmable gate array (FPGA)) configured to execute one or more instructions received from, for example, the memory 220. In some embodiments, the processor 210 can be a Reduced Instruction Set (RISC) processor. As shown in FIG. 2, the processor 210 can be in communication with any of the memory 220 and the network card 230. In some embodiments, the processor 210 can accordingly send information (e.g., data, instructions and/or network data packets) to and/or receive information from any of the memory 220 and the network card 230.

The memory 220 can be any memory (e.g., a RAM, a ROM, a hard disk drive, an optical drive, other removable media) configured to store information (e.g., an operating system, one or more software applications, item image content, item description content, etc.). As shown in FIG. 2, the memory 220 can include the communication module 222, the customer creation module 224 and the content generation module 226. In some embodiments, the memory 220 can include instructions (e.g., code) sufficient to define and/or execute the communication module 222, the customer creation module 224 and the content generation module 226.

The communication module 222 can include software instructions (e.g., code) configured to cause the processor 210 to exchange information (e.g., data packets, data cells) with another hardware device. For example, the communication module 222 can include instructions configured to cause the processor 210 and/or the network card 230 to receive item images and descriptive content and/or other information from a database (e.g., additional content provider 105 of FIG. 1). The communication module 222 can also include instructions configured to cause the processor 210 and/or the network card 230 to exchange one or more data packets with one or more databases (e.g., the content database 130 and/or the marketplace database 140 of FIG. 1). Although not shown in FIG. 2, in some embodiments, the communication module 222 can be any valid combination of hardware and/or software, including, e.g., an ASIC, an FPGA, a firmware module, etc.

The customer creation module 224 can include software instructions (e.g., code) configured to cause the processor 210 to facilitate the creation of customer accounts. The customer information can be stored, for example, at memory 220 or can be stored in a marketplace database, such as marketplace database 140 described above. Although not shown in FIG. 2, in some embodiments, the customer creation module 224 can be any valid combination of hardware and/or software, including, e.g., an ASIC, an FPGA, a firmware module, etc.

The content generation module 226 can include software instructions (e.g., code) configured to create a merchandiser storefront based. In some embodiments, the storefront is created automatically. In other embodiments, the merchandiser selects content for the storefront from a content database (e.g., content database 130 or additional content provider 105). Although not shown in FIG. 2, in some embodiments, the content generation module 226 can be any valid combination of hardware and/or software, including, e.g., an ASIC, FPGA, a firmware module, etc. In an example, the content generation module 226 can include instructions to curate a storefront or a boutique using an inventory of items from the content database. The inventory of items can be a universal inventory or a subset of an entire inventory (e.g., a subset including “great gifts for Mother's Day”). The storefront can be created such that different merchandisers can use the platform to build their own collection or storefront. In other words, even though the merchandisers can create content for their storefront using a similar inventory, the collection of items chosen can differ from one merchandiser to another. From the customer's perspective, when a particular merchandiser is selected from amongst the plurality of merchandisers, the content and storefront associated with the selected merchandiser is presented to the user.

In some embodiments, the content presented to the user and/or the content generated by the merchandiser/content generation module is based on content associated with an event (e.g., a holiday period identified in the content database 130). Alternatively or additionally, the content can be determined based at least in part on user preferences. In other words, content can be presented to a customer based on the customer's profile or based on dynamic filtering or selections made by the customer.

In some embodiments, having determined the user preferences and the relevant merchandiser, the content generation module 226 can next select, from a database, the content to present. For example, the content generation module 226 can send a query to a content database (e.g., the content database 130 of FIG. 1) for a set of images of items falling within a set of defined preferences, from which it can select a single type of item (e.g., bracelets) or multiple items satisfying items in a particular category (e.g., items for sale under $100, items from a particular designer, etc.). Alternatively, the content generation module 226 can send a request to the content database 130 for a single, randomly-selected or pseudo-randomly-selected item for sale and its associated content (e.g., image, description, price, etc.).

The network card 230 can be a hardware module (e.g., a wired and/or wireless Ethernet card, a cellular network interface card) configured to transmit information (e.g., data packets, cells, etc.) from and receive information at the merchandiser generation engine 200. As shown in FIG. 2, the network card 230 can be operatively and/or physically coupled to the processor 210. In this manner, the processor 210 can, via the network card 230, exchange information with one or more other devices via a network (e.g., the public network 110 discussed in connection with FIG. 1 above).

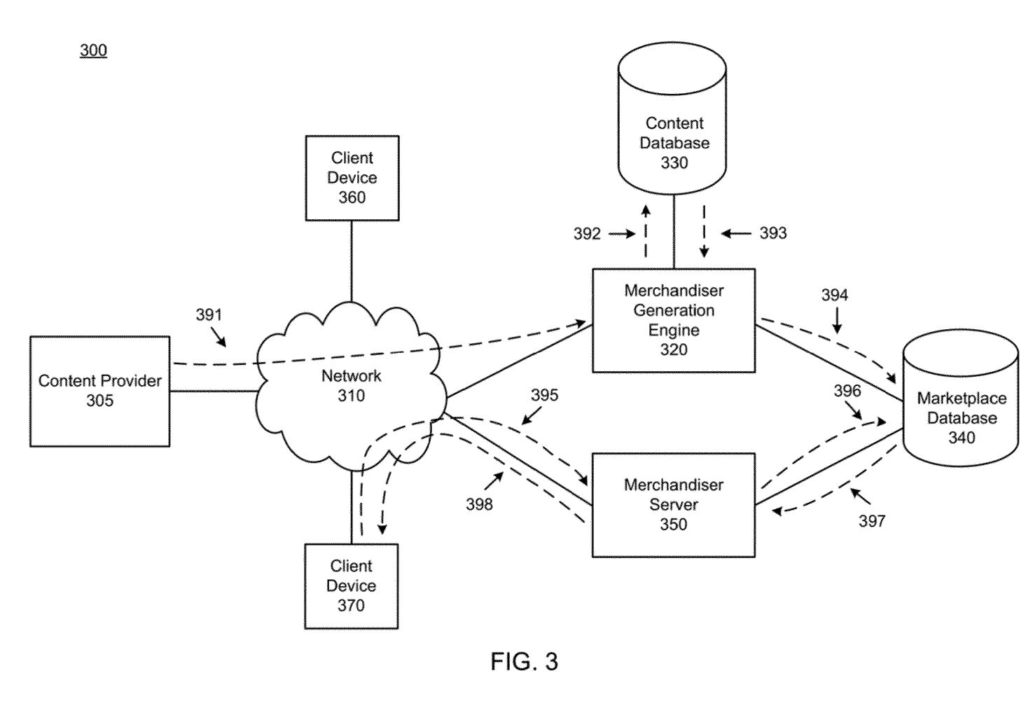

FIG. 3 is a schematic block diagram that illustrates a system for conducting transactions, according to another embodiment. More specifically, FIG. 3 illustrates a merchandiser generation engine 320 operatively coupled to a content provider 305 (via a network 310), a content database 330 and a marketplace database 340. The marketplace database 340 can be further coupled to a merchandiser server 350, which can itself be coupled, via the network 310, to a client device 360 and/or to a client device 370.

The content provider 305 can be any device, system, service and/or entity configured to provide (i.e., send) data, and/or other information associated with a given item, person, designer, industry, class of goods, etc. In some embodiments, the content provider 305 can be similar to the additional content provider 105 discussed in connection with FIG. 1 above. As shown in FIG. 3, the information provider can be operatively and/or physically coupled to the network 310, and to the content generation engine 320 and/or the merchandiser server 350 via the network 310. As further shown in FIG. 3, the content provider 305 can send information to and receive information from the merchandiser generation engine 320 via one or more signals, data packets and/or data cells (e.g., the signal 391 discussed below).

The network 310 can be any computer or information network capable of marshalling and transmitting data between two or more hardware devices, such as the content provider 305, the client device 360, the client device 370, the merchandiser generation engine 320 and the merchandiser server 350. For example, the network 310 can be a local area network (LAN), a wide area network (WAN) or the Internet. In some embodiments, the network 310 can be comprised of one or more wired and/or wirelessly connected hardware devices. The network 310 can optionally be similar to the network 110 discussed in connection with FIG. 1 above.

The merchandiser generation engine 320 can be any combination of hardware and/or software (executing in hardware) configured to define content based at least in part on information received from the content provider 305 and/or the content database 330. The merchandiser generation engine 320 can be, for example, a server device executing one or more software modules configured to organize information (e.g., item descriptors, categories and other data received from the content provider 305 and/or the content database 330) within a particular merchandiser's storefront (e.g., a presentation of items selected from the content database 330 or content provider 305) to define and present an online marketplace (e.g., storefront for designer item sales). In addition, the merchandiser generation engine 320 can also receive, from the content database 330, one or more narratives, prices, and/or descriptors associated with the selected content (e.g., items). In some embodiments, the content generation engine 320 can be similar to the merchandiser generation engine 120 described in connection with FIG. 1 above and/or to the merchandiser generation engine 200 described in connection with FIG. 2 above. As shown in FIG. 3, the merchandiser generation engine 320 can send or receive one or more signals (e.g., the signal 391) to/from the content provider 305 via the network 310. The merchandiser generation engine 320 can additionally exchange one or more signals (e.g., the signals 392 and 393) with the content database 330. As also shown in FIG. 3, the merchandiser generation engine 320 can exchange one or more signals (e.g., the signal 394) with the marketplace database 340.

The content database 330 can be any combination of hardware and/or software (executing in hardware) including one or more content stores, images, identifiers of one or more persons, designers, places, things, items, events, accessory brands, item descriptors, narratives and/or other information associated with the same. Additionally, the content database 330 can store descriptors, categories of items, characteristics of items (e.g., sizes, colors, quality descriptors, etc.), and/or other information associated with one or more items for sale or other information. Such information is for use by the merchandiser generation engine 320 in providing a marketplace or storefront. The content database 330 can optionally be similar to the content database 130 discussed in connection with FIG. 1 above.

The marketplace database 340 can be any combination of hardware and/or software (executing in hardware) storing one or more previously-generated merchandiser storefronts defined by the merchandiser generation engine 320. In some embodiments, the marketplace database 340 can include one or more relational databases including one or more relational database tables, similar in structure, type, format, hierarchy and/or organization to those that are included in the merchandiser generation database 330. Although not shown in FIG. 3, the marketplace database 340 can be included in and/or stored at the same physical device as the content database 330. In such embodiments, one or more tables of the marketplace database 340 can optionally be included in the same database as the content database 330. Alternatively, one or more portions of the marketplace database 140 (e.g., entire databases and/or relational database tables) can be stored across multiple devices, such as database server devices (not shown in FIG. 3). The marketplace database 340 can additionally exchange signals with the merchandiser server 350 so as to provide responses to one or more requests or queries received from the merchandiser server 350. In some embodiments, the marketplace database 340 can be substantially similar to the marketplace database 140 described in connection with FIG. 1 above.

The merchandiser server 350 can be any combination of hardware and/or software (executing in hardware) configured to retrieve and/or serve (i.e., send) storefront content (e.g., previously-generated storefront content stored in the marketplace database 340) to one or more client devices. As shown in FIG. 3, the merchandiser server 350 is operatively coupled, via the network 310, to the client device 360 and to the client device 370. As shown in FIG. 3, the merchandiser server 350 can receive, via a network (e.g., the network 310), one or more requests for content from one or more client devices (e.g., the client device 370). In some embodiments, the merchandiser server 350 can send one or more responses to a requesting client device, the responses including content requested from that client device. In some embodiments, the merchandiser server 350 can be substantially similar to the content server 150 described in connection with FIG. 1 above.

Each of the client device 360 and the client device 370 can be any hardware client device and/or software client module configured to request, receive and/or display narrative content defined by the merchandiser generation engine 320. As shown in FIG. 3, each of the client device 360 and the client device 370 can send such requests and/or receive such responses from the merchandiser server 350 via the network 310. In some embodiments, any or each of the client device 360 and the client device 370 can be a personal and/or mobile computing device executing a web browser program or application. In some embodiments, any or each of the client device 360 and the client device 370 can be substantially similar to the client device 160 and the client device 170 described in connection with FIG. 1 above.

Although not shown in FIG. 3, in some embodiments, any or each of the content provider 305, the merchandiser generation engine 320, the content database 330, the marketplace database 340, the merchandiser server 350, the client device 360 and/or the client device 370 can be comprised of multiple hardware devices and/or software modules.

As shown in FIG. 3, the content provider 305 can send a signal 391 to the merchandiser generation engine 320 via the network 310. The signal 391 can be or include, for example, an Ethernet packet, a data cell, and/or the like, and can include data, images or other such content that may have been requested by the merchandiser. Although shown in FIG. 3 as being sent to the merchandiser generation engine 320, in some embodiments the signal 391 can be sent via the network 310 to the content database 330 for storage and subsequent access by the merchandiser generation engine 320.

The merchandiser generation engine 320 can send a signal 392 to the content database 330. More specifically, the signal 392 can include a request for information related to certain products, classes of products, etc., such as image information, price information, item description, etc. (e.g., in the form of a database request, such as a Structured Query Language (SQL) query) for use in populating the merchandiser storefront with new content. Although not shown in FIG. 3, in some embodiments, the merchandiser generation engine 320 can retrieve the information based on user input, request or known user/customer preferences. Alternatively, the merchandiser generation engine 320 can send the signal 392 in response to one or more triggers, such as a given event (e.g., an upcoming trunk show) associated with a particular merchandiser, a customer request received at the merchandiser generation engine 320, a scheduled event included within a predefined schedule, etc.

As shown in FIG. 3, the content database 330 can also send a signal 393 to the merchandiser generation engine 320. The signal 393 can include, for example, content in response to the signal 392. In some embodiments, the signal 393 is automatically sent based on certain circumstances such as, for example, new product releases, holidays, time of year, etc.

Upon receipt of the signal 393, the merchandiser generation engine 320 can define new storefront content based at least in part on defined preferences (e.g., user or merchandiser), and the received content/information. In some embodiments, the merchandiser generation engine 320 can do so according to the process described in connection with FIG. 2 above and/or the process described below.

Once content is defined, the merchandiser generation engine 320 can send a signal 394 to the marketplace database 340. In some embodiments, the signal 394 can include information such as a merchandiser identifier and a customer or user identifier.

The merchandiser identifier and the customer identifier can be received from the client device 370 via signal 395 sent to the merchandiser server via the network 310. In some embodiments, the signal 395 can include a request for content or a request for a transaction as described below. For example, the signal 395 can be a request formatted according to the Hypertext Transfer Protocol (HTTP) or other known protocol. In the example, the request can be sent from a web browser or other client application executing at the client device 370.

As shown in FIG. 3, the merchandiser server 350 can receive the signal 395. In some embodiments, the merchandiser server 350 can receive the signal 395 at a web server executing at the merchandiser server 350 and operatively coupled to the network 310. In some embodiments, the merchandiser server 350 can next send a signal 396 to the marketplace database 340. In some embodiments, the signal 396 can include a database query/request for data associated with, for example, a particular customer specified by the signal 395. In this manner, the merchandiser server 350 can request, from the merchandiser database 340, information associate with a particular user of the client device 370 (e.g., a customer or a merchandiser).

The merchandiser database 340 can next send a signal 397 to the merchandiser server 350. In some embodiments, the signal 397 can include the content responsive to the database query/request included in the signal 396. In some embodiments, the signal 397 can include Hypertext Markup Language (HTML) content for transmission to a web browser executing at the client device 370.

Upon receipt of the signal 397, the merchandiser server 350 can define a response to the signal 395 for transmission to the client device 370. The response can include, for example, a web page including the content included in the signal 397 and/or other content based thereon. Having defined the response, the merchandiser server 350 can send a signal 398 including the response to the client device 370 (via the network 310). Upon receipt of the signal 398, the client device 370 can optionally display the narrative content (included in, for example a web page) at a client application, such as a web browser executing at the client device 370.

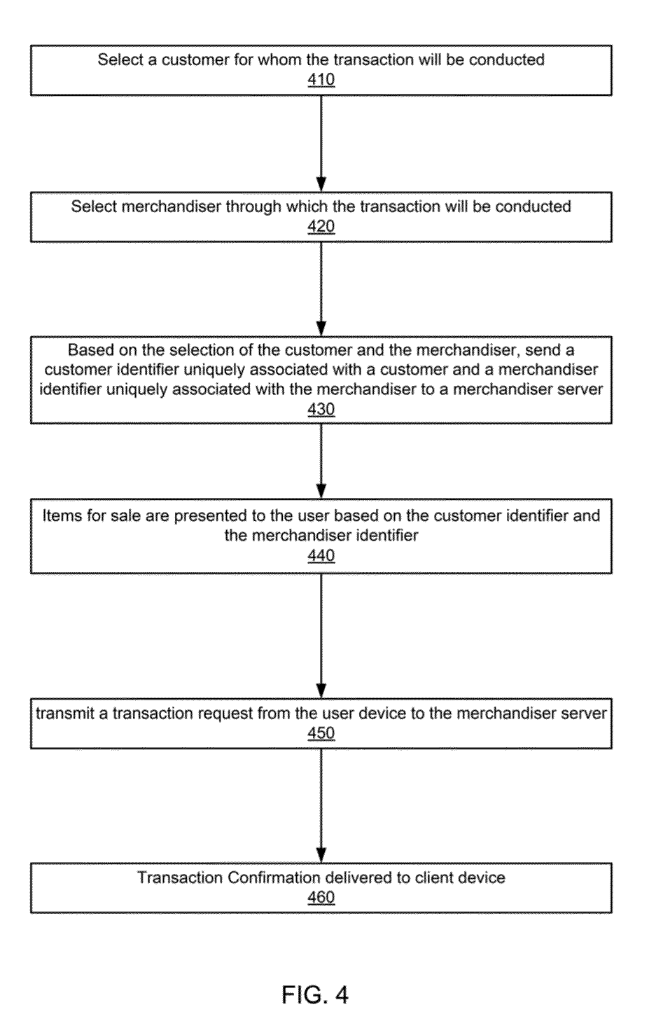

FIG. 4 is a flow diagram that illustrates a method of conducting a transaction, according to an embodiment. In some embodiments, after a merchandiser has populated an online marketplace with content as discussed above, transactions (i.e., purchases) can be made through the marketplace. Utilizing a user interface presented at, for example, client device 370, a user selects a customer for whom the transaction will be conducted, 410. The user also selects a merchandiser through which the transaction will be completed, 420. Based on the selection of the customer and the merchandiser, a customer identifier that is uniquely associated with a customer and a merchandiser identifier uniquely associated with the merchandiser, is sent to, for example, a back-end merchandiser server as discussed above, 430. In some embodiments, the merchandiser information is transmitted automatically when the merchandiser logs into the system.

Items for sale are presented to the user and can vary based on the customer identifier and the merchandiser identifier, 440. As discussed above, based on customer preferences, predefined characteristics and/or merchandiser selections different content is presented. In some embodiments, the displayed content is fixed or is variable based on only one criteria (e.g., customer profile preferences). Once a customer decides to conduct a transaction, a transaction request is transmitted from the user device to the merchandiser server, 450.

Once a transaction is completed, a transaction confirmation is delivered to the client device, 460. In some embodiments, the transaction confirmation is delivered to the same device from which the transaction was initiated. In some embodiments, the transaction confirmation is delivered to a different device or to different recipient at the same device. For example, in certain situations, the merchandiser may act as a proxy for a customer in terms of initiating a transaction. In a trunk show setting, for example, a merchandiser may have the profiles of attendees or regular customers pre-populated and accessible through the client device. In such a scenario, the merchandiser may enter purchase requests through the client device.

To confirm the transaction, the actual customer may receive a communication from, for example, the merchandiser server regarding the transaction and requesting confirmation that the customer would like to complete the transaction. In some embodiments, the customer may be asked to provide, for example, credit card information where none is associated with the customer, or the security code associated with a known credit card in the user's profile. In some embodiments, such a confirmation may be conducted through the client device by the customer rather than at a second client device.

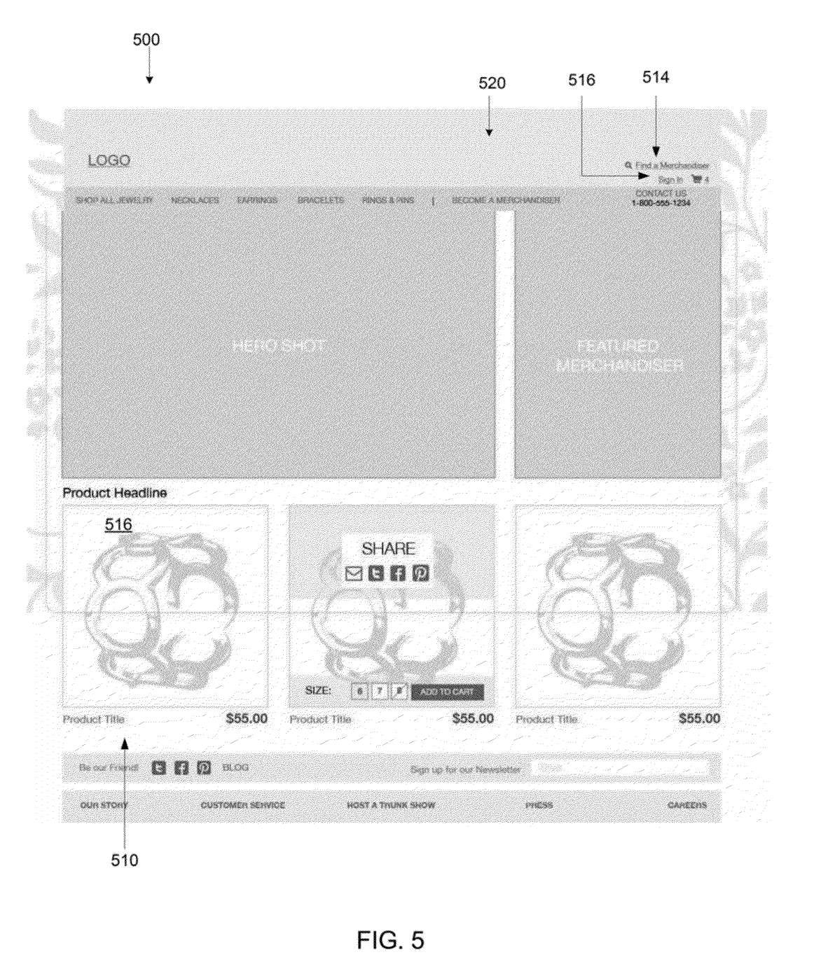

In some embodiments, to facilitate the completion of a transaction, information associated with the customer and the merchandiser are presented via a persistent header available to the merchandiser on the display of the client device. As illustrated in FIG. 5, an example of a user interface 500 according to an embodiment includes a content portion 510 and a persistent portion 520. As illustrated in FIG. 5, the persistent portion provides the user the ability to sign into their account via a sign in link 512 if the user has an existing account. The user can also search for a particular merchandiser using a link 514. The content portion of the interface presents items 516 for sale. Such items presented at the initial interaction with the user interface can be default items, “hot” items, etc. Once the user logs in to their account, the items 516 can be changed to be based on customer preferences, merchandiser preferences, etc. as discussed above.

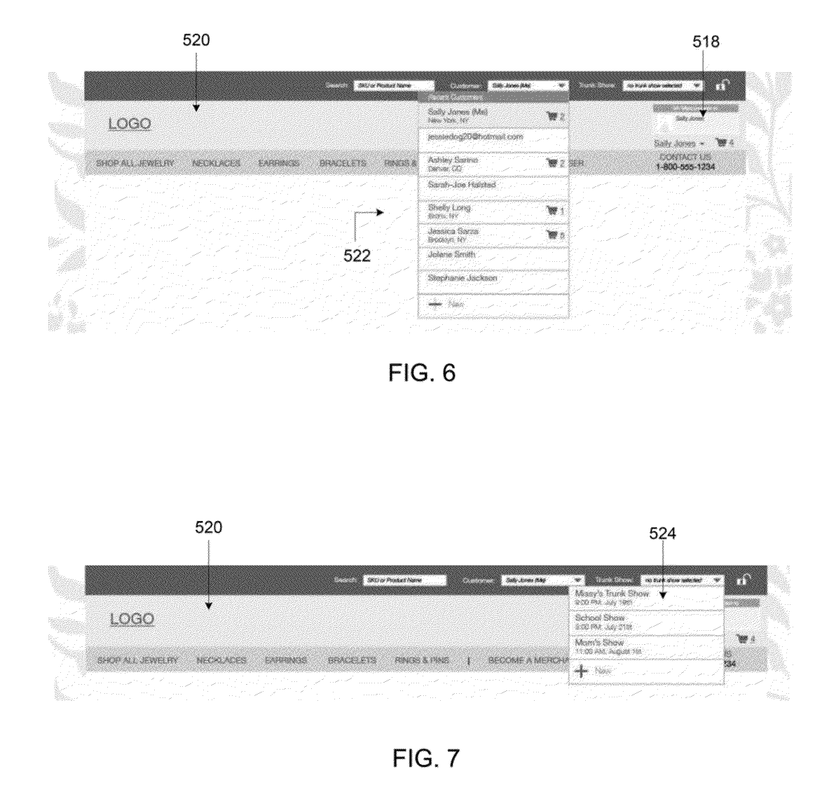

Referring now to FIG. 6, only the persistent portion 520 of the interface 500 is illustrated for ease of reference. Once the merchandiser is selected from the persistent portion 520 and/or the merchandiser is logged in, the merchandiser information 518 is presented on the user interface. In this example, the merchandiser is “Sally Jones.” The user is then able to select a customer from the customer drop down portion 522 of the persistent portion 520. Once a customer is selected, the merchandiser can transact business on behalf of the selected customer.

A merchandiser can also add a new customer by selecting the “NEW” link from the customer drop down portion 522. A new window will be presented and information about the new customer can be added. The next time the customer drop down menu is accessed, the new customer information will be present.

FIG. 7 illustrates the persistent portion 520 of the user interface 500 in the context of a trunk show. In such a scenario, the merchandiser can search for a particular trunk show from a trunk show drop down menu 524. The user can also choose the “NEW” trunk show link and will be taken to a separate window to add information for a new trunk show. Once the relevant information is entered, the next time the trunk show drop down menu 524 is accessed, the new trunk show information will be present.

As discussed above, when a particular customer is selected from the plurality of customers, the items for sale presented to the customer can be varied based on customer preferences. Additionally, any transaction conducted after selection of the particular customer will be conducted on behalf of that customer. Said another way, the user interacting with the user interface acts as a proxy for the customer. In other words, the merchandiser at a trunk show can enter transaction information (i.e., order selected items) on behalf of a customer or multiple customers through the user interface.

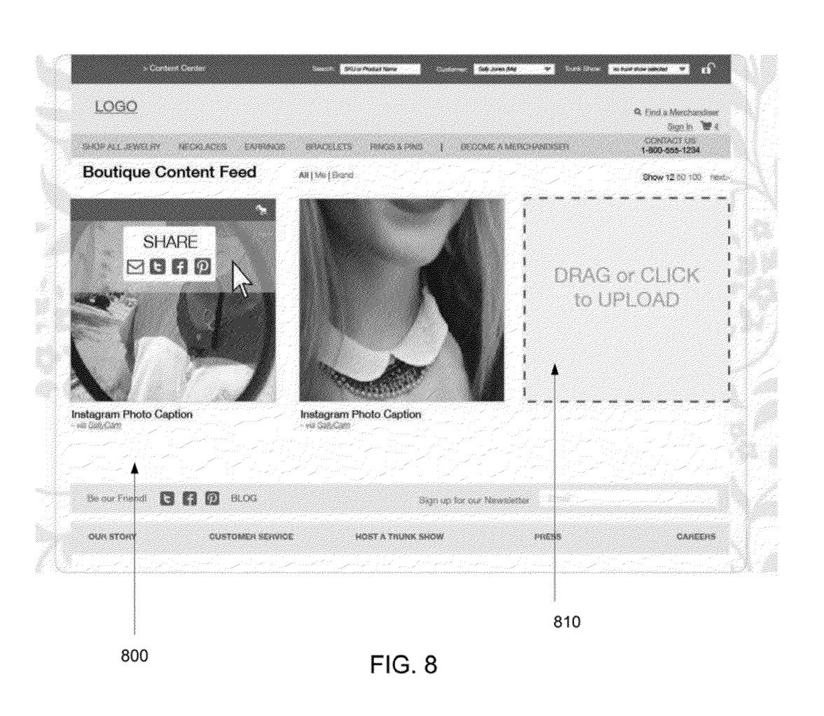

As discussed above, a merchandiser can curate their own boutique using either “stock” images, images from third parties, or personal images. FIG. 8 is an example of a user interface 800 through which a merchandiser can populate their “storefront” or boutique with personal images 810. The merchandiser can retrieve photos from sources such a photo library on the merchandiser's computer, from a social network or photo-sharing site, or from a variety of other sources. In some embodiments, the user can populate the user interface 800 with images 810 that were taken by others, but are retrievable from similar sources.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the systems and/or methods described herein may be combined in any combination, except mutually exclusive combinations. The embodiments described herein can include various combinations and/or sub-combinations of the functions, components and/or features of the different embodiments described.

What is claimed is:

1. A method, comprising:
sending from a user device customer identifier data uniquely associated with a customer;
sending from the user device merchandiser identifier data uniquely associated with a merchandiser from a plurality of merchandisers;
displaying at least one item for sale based on data received from a server, the data displayed based on a profile associated with the customer identifier and the merchandiser identifier; and
transmitting from the user device data associated with at least one transaction request for the at least one item for sale, the customer identifier data and the merchandiser identifier being accessible via a persistent portion of a user interface of the user device.

2. The method of claim 1, wherein the sending the merchandiser identifier data occurs automatically based on a merchandiser login.

3. The method of claim 1, wherein the sending the customer identifier data is based on a selection of a customer identifier from the persistent portion of the user interface.

4. The method of claim 1, wherein the displaying includes displaying items for sale based on a merchandiser collection profile including a plurality of items for sale, the plurality of items being prepopulated by the merchandiser.

5. The method of claim 1, wherein the displaying includes displaying items for sale, the items for sale being a subset of a set of items of a merchandiser collection profile, the subset being displayed based on a selection of a category from the persistent portion of the user interface.

6. The method of claim 1, further comprising receiving a transaction confirmation request at the user device.

7. The method of claim 1, the user device being a first user device, wherein the transmitting initiates a transaction confirmation request to be sent to a second user device.

8. The method of claim 1, wherein the displaying is based on a merchandiser collection, the merchandiser collection including indications of items selected from a database, the database being accessible by a plurality of merchandisers, the selecting done by only a merchandiser associated with the merchandiser collection.

9. The method of claim 8, wherein the merchandiser collection further includes indications of items selected from a second database accessible by only the merchandiser.

10. The method of claim 8, wherein the database is accessible via the persistent portion of the user interface.

11. A method, comprising:
receiving, from a first user device, a customer identifier, the customer identifier being one customer identifier from a plurality of customer identifiers, each customer identifier from the plurality of customer identifiers being uniquely associated with a separate customer, the customer identifier being selectable from a persistent header of the user device;
receiving, from the first user device, a merchandiser identifier, the merchandiser identifier being one merchandiser identifier from a plurality of merchandiser identifiers, each merchandiser identifier from the plurality of merchandisers being uniquely associated with a merchandiser, the merchandiser being selectable from the persistent header of the user device;
receiving a transaction identifier associated with a transaction based on the customer identifier and the merchandiser identifier;
sending data associated with a transaction completion request; and
receiving data associated with a transaction completion in response to the transaction completion request.

12. The method of claim 11, wherein the sending data includes sending data associated with the transaction completion request to the first user device.

13. The method of claim 11, wherein the sending data includes sending data associated with the transaction completion request to a second user device different from the first user device.

14. A non-transitory processor-readable medium storing code representing instructions to be executed by a processor, the code comprising code to cause the processor to:
send from a user device customer identifier data uniquely associated with a customer;
send from the user device merchandiser identifier data uniquely associated with a merchandiser from a plurality of merchandisers;
displaying at least one item for sale based on data received from a server, the data displayed based on a profile associated with the customer identifier and the merchandiser identifier; and
transmit from the user device data associated with at least one transaction request for the at least one item for sale, the customer identifier data and merchandiser identifier accessible via a persistent portion of a user interface of the user device.

15. A non-transitory processor-readable medium storing code representing instructions to be executed by a processor, the code comprising code to cause the processor to:
receive, from a first user device, a customer identifier, the customer identifier being one customer identifier from a plurality of customer identifiers, each customer identifier from the plurality of customer identifiers being uniquely associated with a separate customer, the customer identifier being selectable from a persistent header of the user device;
receive, from the first user device, a merchandiser identifier, the merchandiser identifier being one merchandiser identifier from a plurality of merchandiser identifiers, each merchandiser identifier from the plurality of merchandisers being uniquely associated with a merchandiser, the merchandiser being selectable from the persistent header of the user device;
receive a transaction identifier associated with a transaction based on the customer identifier and the merchandiser identifier;
send data associated with a transaction completion request; and
receive data associated with a transaction completion in response to the transaction completion request.

16. The non-transitory processor-readable medium of claim 15, wherein the sending data includes sending data associated with the transaction completion request to the first user device.

17. The non-transitory processor-readable medium of claim 15, wherein the sending data includes sending data associated with the transaction completion request to a second user device different from the first user device.
